(19) United States
(12) Patent Application Publication
(10) Pub. No.: US 2015/0228006 A1
(43) Pub. Date: Aug. 13, 2015

(54) SYSTEM AND METHOD FOR CREATING, MANAGING AND FULFILLING SALES LEAD ORDERS

(71) Applicant: Underground Elephant, San Diego, CA (US)

(72) Inventors: Keola Malone, San Diego, CA (US); Jason Kulpa, San Diego, CA (US)

(21) Appl. No.: 14/617,893

(22) Filed: Feb. 9, 2015

Related U.S. Application Data
(60) Provisional application No. 61/937,420, filed on Feb. 7, 2014.

(51) Int. Cl. G06Q 30/06; G06Q 30/02; G06Q 10/06

(52) U.S. Cl. CPC G06Q 30/0635; G06Q 10/06393; G06Q 30/0283

(57) ABSTRACT

A system and method for creating, managing and fulfilling sales leads orders. A new order for sales leads is created based on one or more predefined properties of the sales leads specified by a user. One or more profile elements for the number of the sales leads is generated, defining a plurality of segments of the number of the sales leads. A pricing structure for the number of the sales leads is calculated based on the one or more profile elements, and the new order and the pricing structure are provided to the customer electronically via a communications network.

### CROSS-REFERENCE TO RELATED APPLICATION

This application claims priority under 35 U.S.C. §119(e) to U.S. Provisional Patent Application Ser. No. 61/937,420 filed on Feb. 7, 2014 and entitled “System and Method for Creating, Managing and Fulfilling Sales Lead Orders” the disclosure of which is incorporated by reference herein in its entirety.

### TECHNICAL FIELD

The subject matter described herein relates to computer-implemented methods, software, and systems, centralized in a single platform, for creating, managing and fulfilling sales lead orders.

### BACKGROUND

With the advent of digital marketing, sales agents have more resources than ever to reach potential customers (i.e. sales leads). However, these resources are disparate and modular, with limited opportunities for easy integration, causing confusion and inefficiency within full-cycle marketing processes (i.e. lead to conversion).

In general, the marketing process starts with sales. The value of sales leads is based on the amount, validity, applicability, exclusivity and age of information provided about a prospective consumer of a product or service. A maximum value per lead is achieved by optimally matching individual leads with individual buyer's specific criteria. Since sales leads are generated using relatively broad reach marketing strategies, it is necessary to have a large and diverse set of buyers in order to ensure the percentage of leads sold is as high as possible. Traditionally, the cost of integrating and supporting large quantities of sales lead buyers is prohibitively expensive. The result is low lead value, high buyer support costs, and/or high unsold lead percentages.

Lead acquisition platforms and lead management systems help agents initiate the sales process, but they are segmented from other critical marketing functionalities (CRM, policy quoting platforms, automated contact platforms, and email marketing systems), meaning sales agents cannot manage and complete the marketing and sales process, in its entirety, within a single platform. Instead of operating in a streamlined, integrated system, agents' marketing efforts and sales pipelines are bottlenecked by a disparate patchwork of technical solutions and temporary fixes (numerous API integrations and data exports). Furthermore, enterprise-level data (i.e. aggregate sales performance of agents at local, regional, and national level) goes largely underutilized, meaning agents do not know how they are doing compared to their peers.

### SUMMARY

The computer-implemented methods, software, and systems are presented for the management and fulfillment of an integrated marketing and sales process (i.e. a single marketing interface), as performed by sales agents.

In one aspect, a system and method for creating, managing and fulfilling sales leads orders includes the steps of creating a new order for sales leads, the creating being based on one or more predefined properties of the sales leads specified by a user, the new order specifying a number of the sales leads to be transmitted electronically to a customer. The system and method further include generating one or more profile elements for the number of the sales leads, the one or more profile elements defining a plurality of segments of the number of the sales leads. The system and method further include calculating a pricing structure for the number of the sales leads based on the one or more profile elements, and providing the new order and the pricing structure to the customer electronically via a communications network. The system and method further include receiving, via the communications network, a selection by the customer of one or more of the plurality of segments of the number of sales leads, the selection further defining a price for the selection based on the pricing structure.

Implementations of the current subject matter can include, but are not limited to, systems and methods consistent including one or more features are described as well as articles that comprise a tangibly embodied machine-readable medium operable to cause one or more machines (e.g., computers, etc.) to result in operations described herein. Similarly, computer systems are also described that may include one or more processors and one or more memories coupled to the one or more processors.

A data storage memory, which can include a computer-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to an enterprise resource software system or other business software solution or architecture, it should be readily understood that such features are not intended to be limiting. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 depicts a graphical user interface used by prospective buyers to apply for access to purchase sales leads;

FIG. 2 depicts a graphical user interface used by buyers to quickly view the status of their account and orders;

FIG. 3 depicts a graphical user interface used at the beginning of the new order creation process;

FIG. 4 depicts the graphical user interface for Step 2 of the new order creation process;

FIG. 5 depicts a graphical user interface used to select the geographic location of sales leads;

FIG. 6 depicts a graphical user interface used by buyers to fund their account;

FIG. 7 depicts a graphical user interface that can be used to fund an order;

FIG. 8 depicts a graphical user interface used by buyers to view and manage leads purchased;

FIG. 9 depicts a graphical user interface illustrated in FIG. 8 after the filter menu collapsed;

FIG. 10 depicts a graphical user interface used to view detailed lead information when the Lead Details action button is used in FIG. 9;

FIG. 11 depicts a graphical user interface used by lead vendors to act on lead return requests;

FIG. 12 depicts a graphical user interface from FIG. 11 with the filter menu collapsed;

FIG. 13 depicts a graphical user interface used lead vendors to manage system users;

FIG. 14 depicts a graphical user interface used by lead vendors to view and manage billing transactions;

FIG. 15 depicts an example of a receipt created through the interface depicted in FIG. 14; and

FIG. 16 depicts a graphical user interface used by lead buyers and lead vendors to view leads previously made available for sale through the system;

FIG. 17 is a functional block diagram of a system for creating, managing and fulfilling sales lead orders;

FIG. 18 illustrates a process executed by the order creation module, in accordance with some implementations;

FIG. 19 illustrates a process executed by the lead management module, in accordance with some implementations; and

FIG. 20 illustrates a process executed by the conversion tracking and disposition data module.

When practical, similar reference numbers denote similar structures, features, or elements.

### DETAILED DESCRIPTION

To address these and potentially other issues with currently available solutions, methods, systems, articles of manufacture, and the like consistent with one or more implementations of the current subject matter can, among other possible advantages, provide computer-implemented methods, software, and systems for creating, managing and fulfilling sales lead orders.

In some implementations, a system and method include the functionality of:
A Lead Acquisition Platform (LAP)
A Vendor Management System (VMS)
A Lead Management System (LMS)
A Quoting Platform (QP)
A Contact Platform (CP)
A Customer Relations Management (CRM) Platform
An Email Marketing System (EMS)
A Mobile App
Social Media audience targeting using social media data
Gamification

In accordance with some implementations, a system includes a lead acquisition platform (LAP) that provides an interface allows agents to acquire, manage, and fulfill sales lead orders from multiple vendors in a single marketing platform/system. Sales leads can be segmented based on product type, as well as consumer profiles and geography. Proprietary algorithms forecast lead volumes based on their respective market categories. Proprietary data hygiene ensures sales lead quality by verifying lead sources and protecting against fraud. This platform provides the ability to distribute and route leads to one or multiple interfaces, via email and application programming interfaces (API), delivering leads, and integrates with common third-party solutions. When sales leads result in sales (i.e. conversions), this lead-to-sale data is tracked in real-time, providing quote-to-close information at both the vendor and market-segment level in a single, integrated platform. Billing for platform users (e.g. sales agents) allows them to accept and process multiple payment types and allocate their budgets across multiple vendors in a single system.

The system can further include a vendor management software (VMS) system and method that allows sales agents to perform the following functions in a single marketing interface: (a) manage vendors by activating/deactivating lead sources, (b) enterprise-level vendor management automation to grant/deny access to the system based on key compliance and performance indicators, (c) return leads from multiple vendors using API's to programmatically manage process, (d) conversion tracking by lead source, (e) integrate with other preferred VMS platforms.

The system can further include a lead management software (LMS) system and method that allows agents to perform numerous functions in a single marketing interface. Lead disposition puts tags on sales leads, allowing agents to perform sales-cycle tracking Centralized data storage delivers historical tracking of agent performance, and integrates with third party CRM platforms. The LMS system offers agents dynamic pricing and bidding, which is driven by the system's ping post functionality, along with the underlying algorithms for programmatic buying and selling, as well as predictive revenue, cost, and quality of sales leads. To protect against sales lead fraud, the system has a built-in validation and scrubbing process.

The system can further include a customer relationship management (CRM) system and method that links sales cycle functionality to customer relations' management tools, including appointment setting, cross-sell scheduling, triggered event actions (birthdays, business anniversaries, etc), and outreach (email/text messages) that is scheduled by date/time. Agents can upload and integrate their book of business into the marketing interface.

The system can further include a quoting platform and method that automates quote delivery and generation, using enterprise-level quoting data to generate first-impression price proposals and funneling the information directly through the LMS system. This ensures that the quote is as accurate as the information that comes in on the lead. Agents can also set which discounts and IS score to apply. Mass mailing gives agents the ability to produce automated quotes in bulk to streamline outreach to targeted audiences within their customer contact lists. The quoting platform also gives agents the ability to requote old quotes, meaning they can search, reprint, and remail saved quotes. Agents can filter by IFS scores and adjust effective dates to account for an early signing discount. Since this happens in a single marketing interface, agents can search their existing book of business to identify cross-sell opportunities.

The system can further include an integrated contact platform that identifies the best engagement channel for each sales lead in real time. For sales leads that are unavailable during the first outreach attempt, they are funneled into a follow-up queue and linked to the interface's CRM system. The contact platform interfaces with non-agent IVR systems, allowing for warm transfers and appointments, meaning they are transferred to agent's dedicated lines or schedule appointments based on agent availability. The system can also include a calendar and reminder system, which may be hosted in the contact platform, ensuring that agents' workflow is centralized in a single calendar that can sync with many other common third-party calendar systems.

In some implementations, the system can further include an email marketing system allows sales agents to engage customers based on their interests and engagement channels. Email outreach can be set up as automated one-time, ongoing, or triggered campaigns. A/B testing and customer tracking also provides granular data that enables agents to segment their outreach strategies.

The system includes a mobile integration system and method that integrates with agents' mobile devices, such as mobile phones, tablet computers, or the like. For example, the system's calendar and various dashboards can send alerts and push notifications to agents' mobile devices. When consumers click hyperlinks and buttons on their mobile devices, dialing outbound calls from their mobile phones, these calls are routed directly to the agent's mobile device. Location services and mapping tools show agents the existing and potential clients that are in their vicinity. The address and range can be adjusted manually, or set automatically.

The system integrates with any of a number of third party or proprietary social media applications to help agents identify and engage new customers. Within the interface, agents can see the contacts and friends they share with sales leads. Consumers can use their personal social media account credentials to auto fill forms sent to agents. Agents can also set up social media referral campaigns to drive new sales leads via current customers sharing with their networks. The system also performs a content scrape, based on numerous manual or preset filters, to collect a list of suggested contacts as potential customers.

In some implementations, the system provides cross-functional gamification to promote agents' professional development and sales performance. Regional, state, and national benchmarks show agents where they rank among their peers. As system users optimize their actions and/or improve their sales performance, they receive points that are tied to regional, state, and national loyalty programs and rewards. Agents can also assemble their own teams among fellow agents to compare performance among preferred peers.

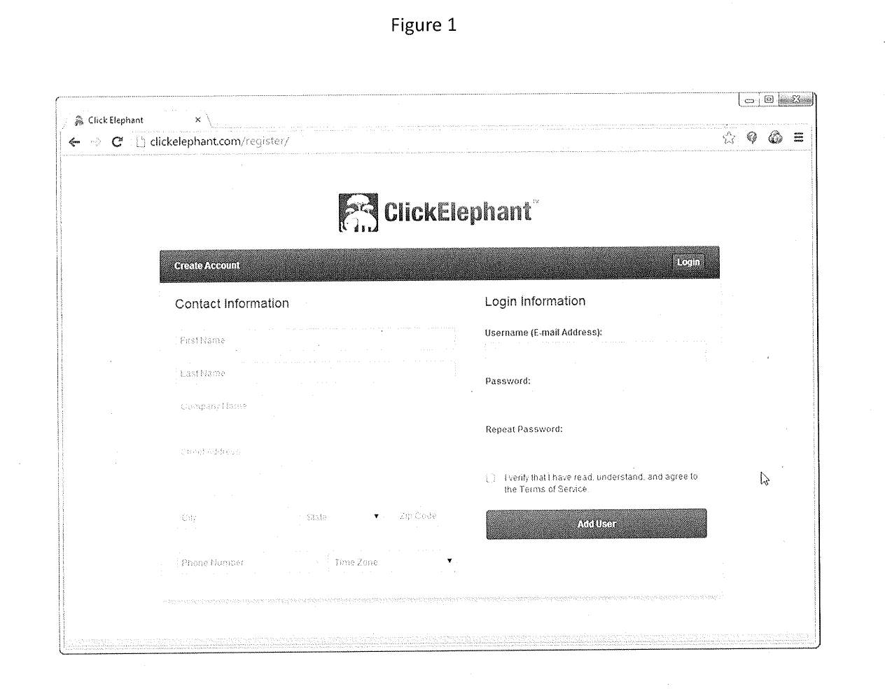

FIGS. 1-16 depict various graphical user interfaces generated by the system to interact with a user for creating, managing and fulfilling sales lead orders. FIG. 1 depicts the graphical user interface used by prospective buyers to apply for access to purchase sales leads. Displayed is a configurable set of profile questions about the buyer that will be used by the sales lead vendor to approve/deny the application.

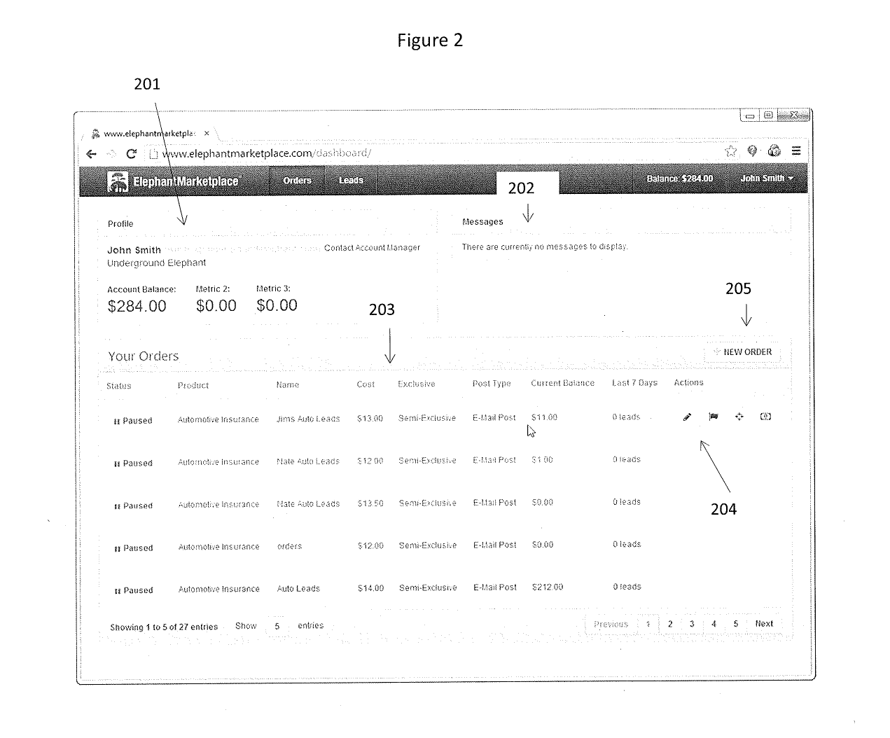

FIG. 2 depicts a graphical user interface used by buyers to quickly view the status of their account and orders. Through the interface, buyers can view their account balance and metrics they define 201, view system generated alerts and customer service messages 202, and view status and descriptive statistics for orders 203. In addition, they can access the edit, filter, target geography, and funding options for existing orders 204. Further, buyers can choose to create a new order 205.

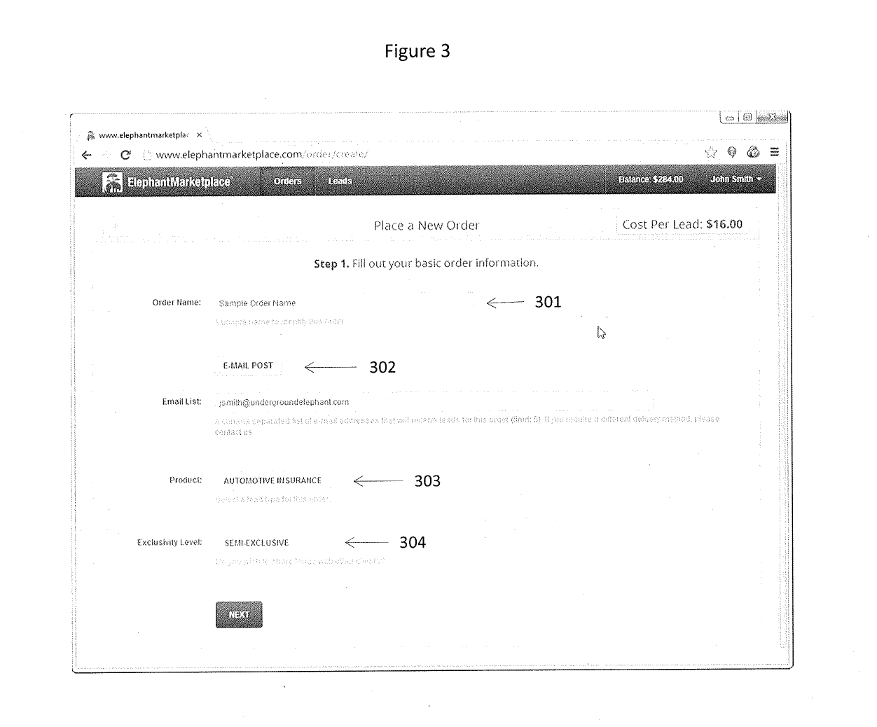

FIG. 3 depicts a graphical user interface used at the beginning of the new order creation process. Through the interface, buyers can specify an order name 301, delivery method for purchased sales leads 302, the type of sales lead 303, the exclusive level for leads 304, and price per leads based on options selected. In this implementation, deliver methods include email, direct post into customer relationship management systems, lead prosecution systems and dialing applications.

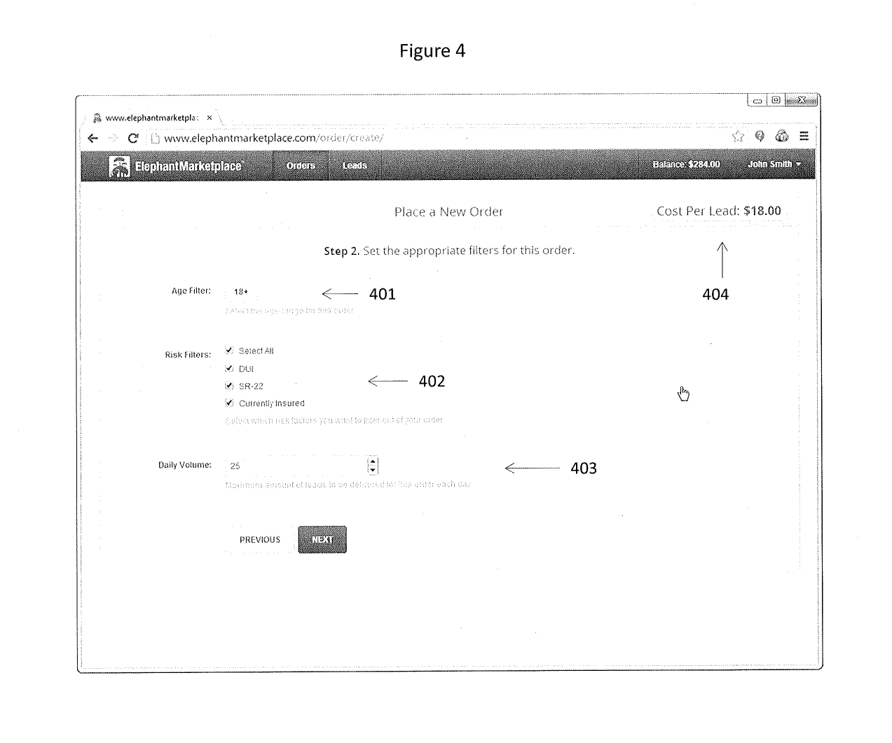

FIG. 4 depicts a graphical user interface for Step 2 of the new order creation process. Through this interface, buyers specify the properties of leads that they would like to purchase. The properties vary by lead type. In this implementation, buyers specify the desired age range 401, exclude leads based on risk factors 402, and set the maximum number of leads that they would like each day 403. The system calculates and displays updated pricing 404 with the selection of each profile element. System administrators configure pricing for individual profile elements as well as bundles of elements by buyer, buyer type, and buyer's parent company/affiliated organization.

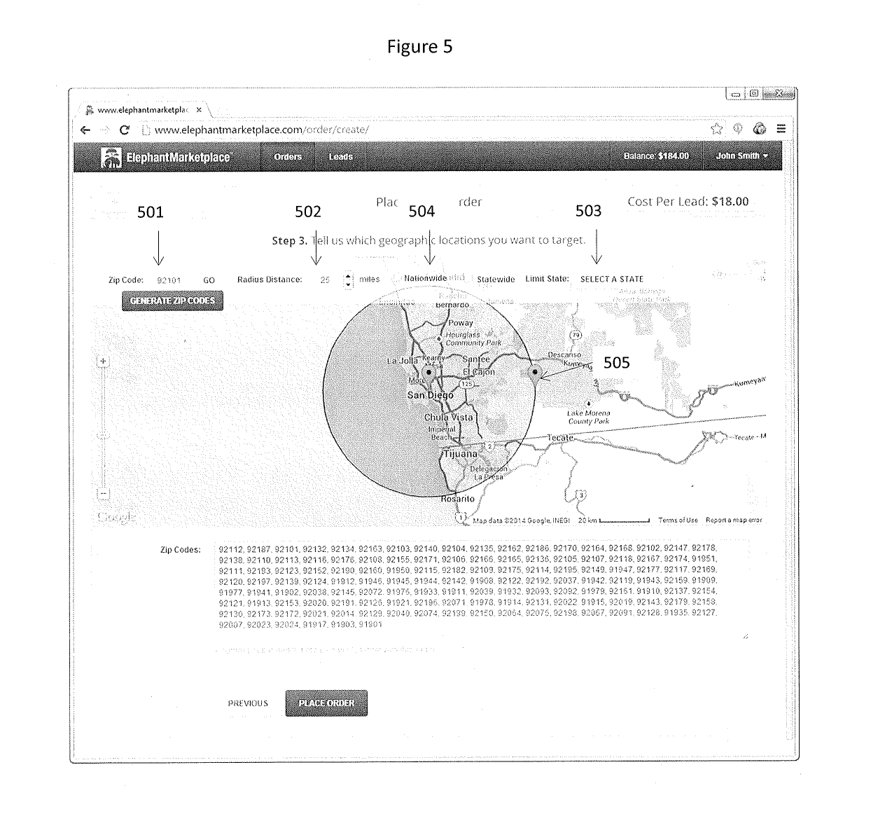

FIG. 5 depicts a graphical user interface used to select the geographic location of sales leads. Through the interface, buyer can specify acceptable locations by zip codes 501, zip codes within a selected region around a base zip code 502, entire states 503, and nationwide 504. Users may adjust the radius through either the input box 502 and/or dragging the circle on the map 505. Administrators can specify whether or not to include sales leads from states outside of the base zip code state.

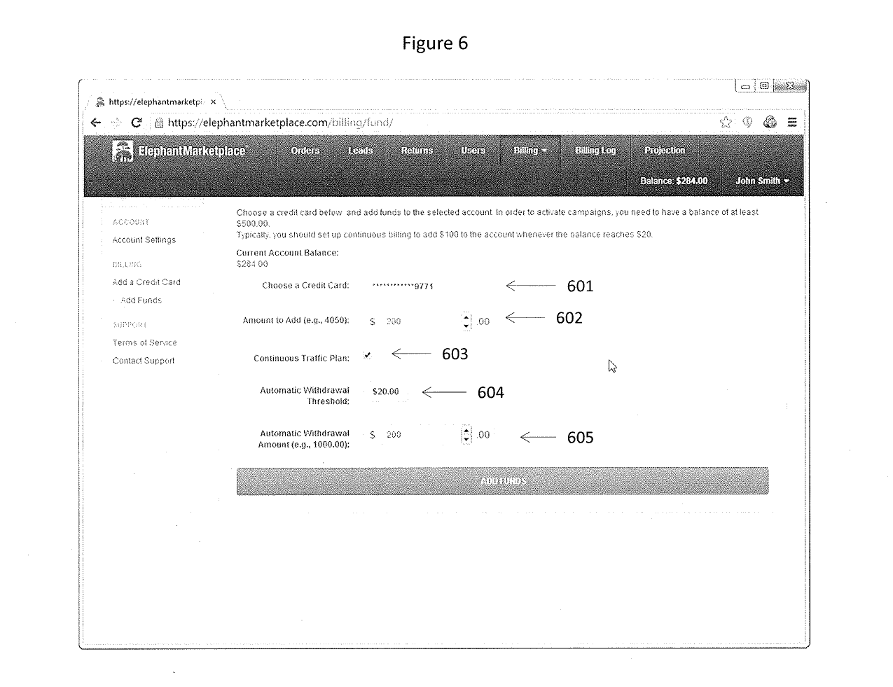

FIG. 6 depicts a graphical user interface used by buyers to fund their account. The system allows for funding at both the account and order level. In this implementation, orders draw funds from accounts. Accounts are funded via credit card. Through the interface, buyers can choose to use an existing credit card or add a new one 601, designate the funding amount 602, enable automatic funding 603 when the account balance dips below a threshold 604, and enter an amount for automatic funding transactions 605. Administrators can specify the funding threshold below which the system will automatically pause the all orders associated with the account. This value can be a negative number. Further, the system sends transaction confirmation and balance alert emails based on administrator configurations.

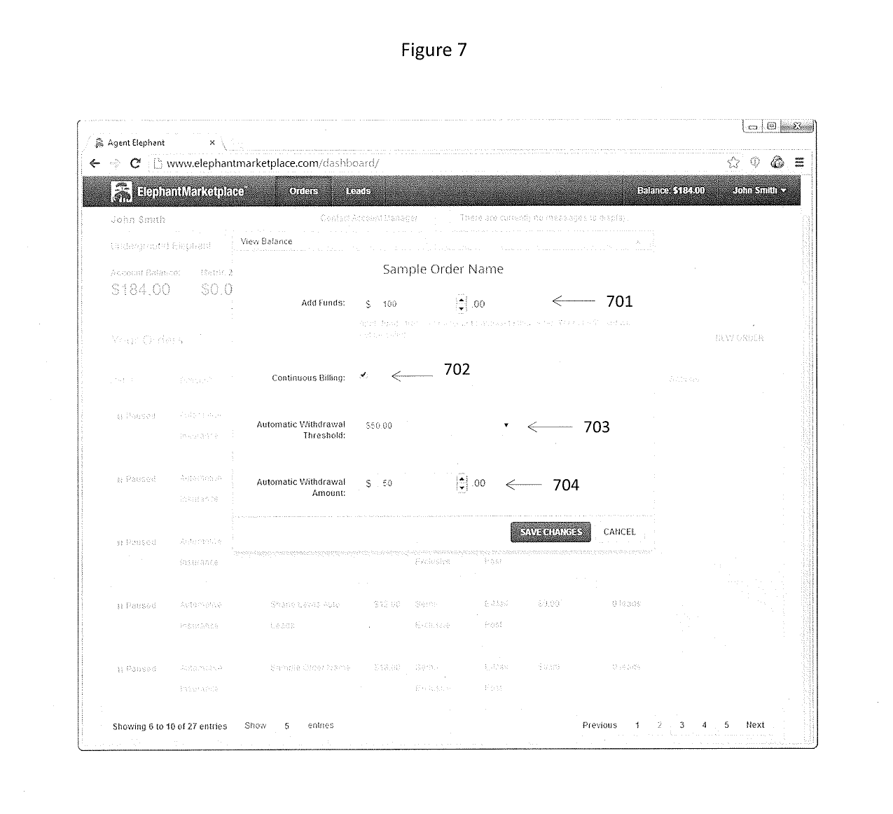

FIG. 7 depicts a graphical user interface that can be used to fund an order, in accordance with some implementations. In a particular implementation, orders draw funds from the buyer's primary system account. Through the interface, buyers designate the funding amount 701, enable automatic funding 702 when the account balance dips below a threshold 703, and enter an amount for automatic funding transactions 704. Administrators can specify the funding threshold below which the system will automatically pause the order. This value can be a negative number.

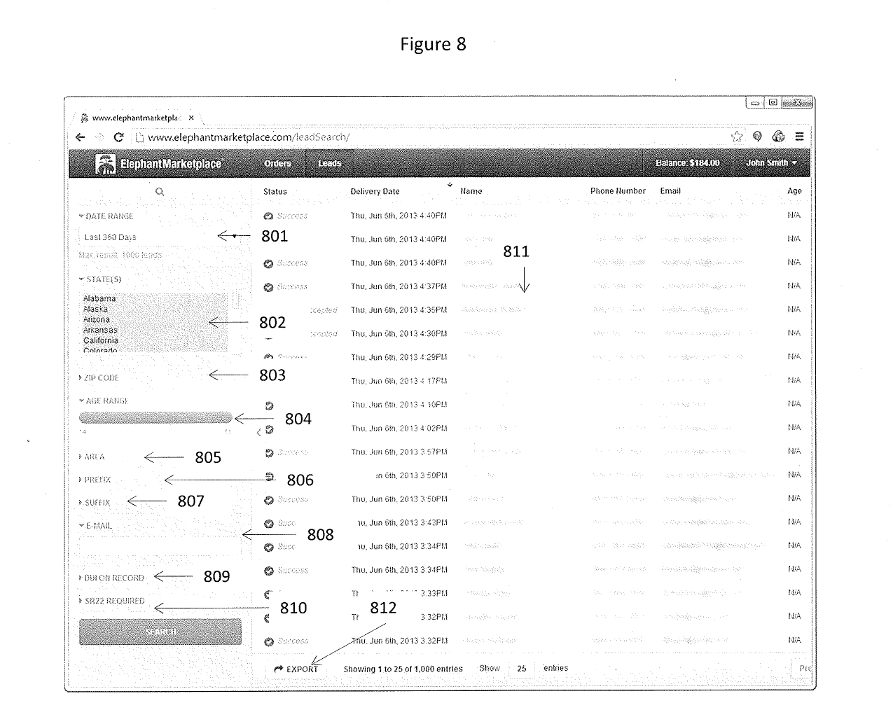

FIG. 8 depicts a graphical user interface used by buyers to view and manage leads purchased. Through the interface, buyers can filter leads based on criteria specific to the associated lead type. In this implementation, buyers can filter automobile insurance leads based on date purchased 801, state 802, zip code 803, age range 804, area code 805, phone number prefix 806, phone number suffix 807, email 808, driving record 809, and required filings 810. Once the filters are specified, the system will display a set of leads 811 and allow the buyer to export the set 812 as a text file.

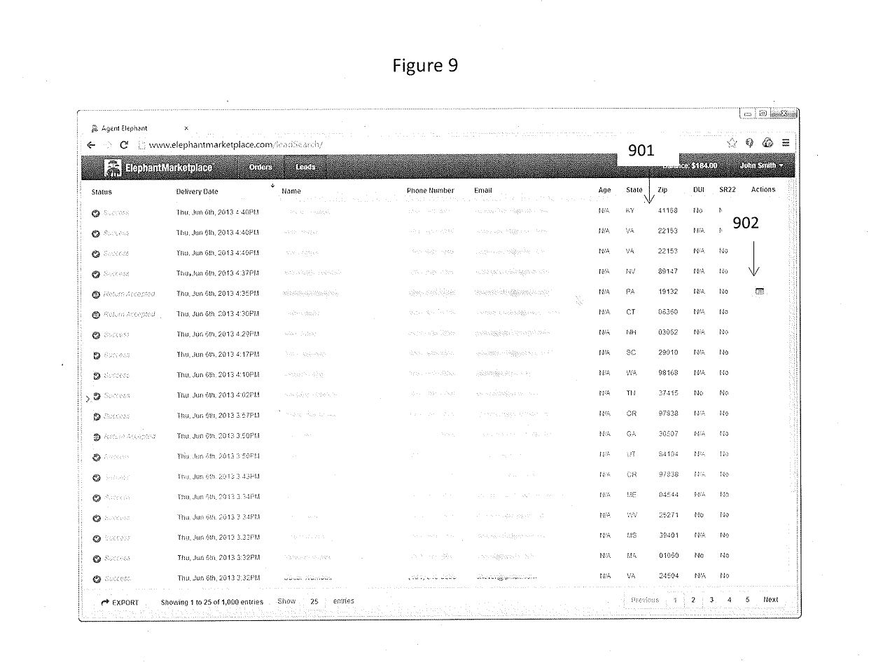

FIG. 9 depicts a graphical user interface illustrated in FIG. 8 after the filter menu collapsed. Collapsing the menu exposes more details about the lead 901 as well as action buttons 902. The action buttons allow buyers to view lead details as well as request authorization to return the lead. System administrators can use fixed quantity and percentage of sales to set thresholds for automatic return authorization by account and/or order. Return requests above the threshold are queued for review by lead vendors. The system automatically sends disposition emails for each lead acted on by a lead vendor. The filter menu can be accessed by selecting the expand arrow.

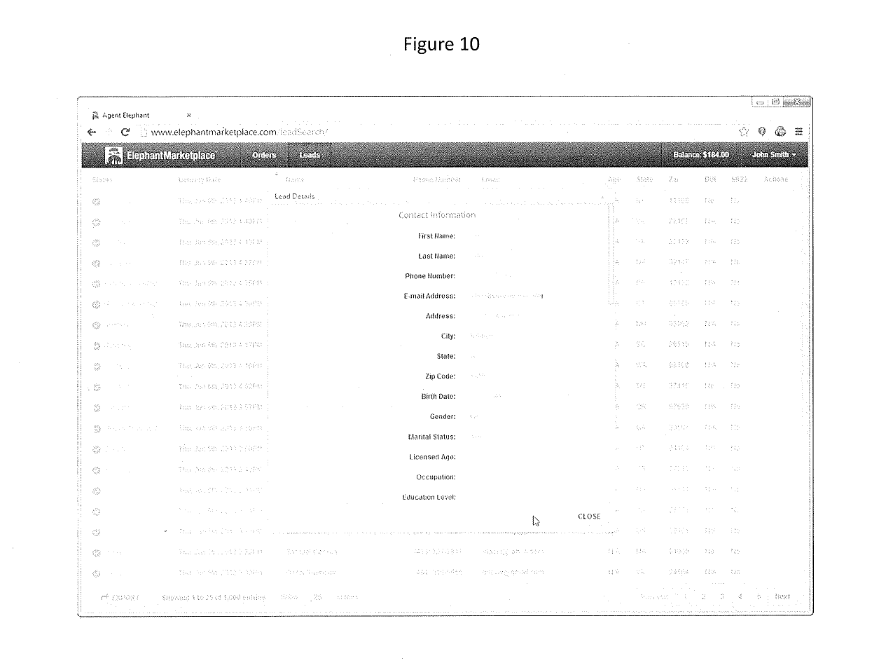

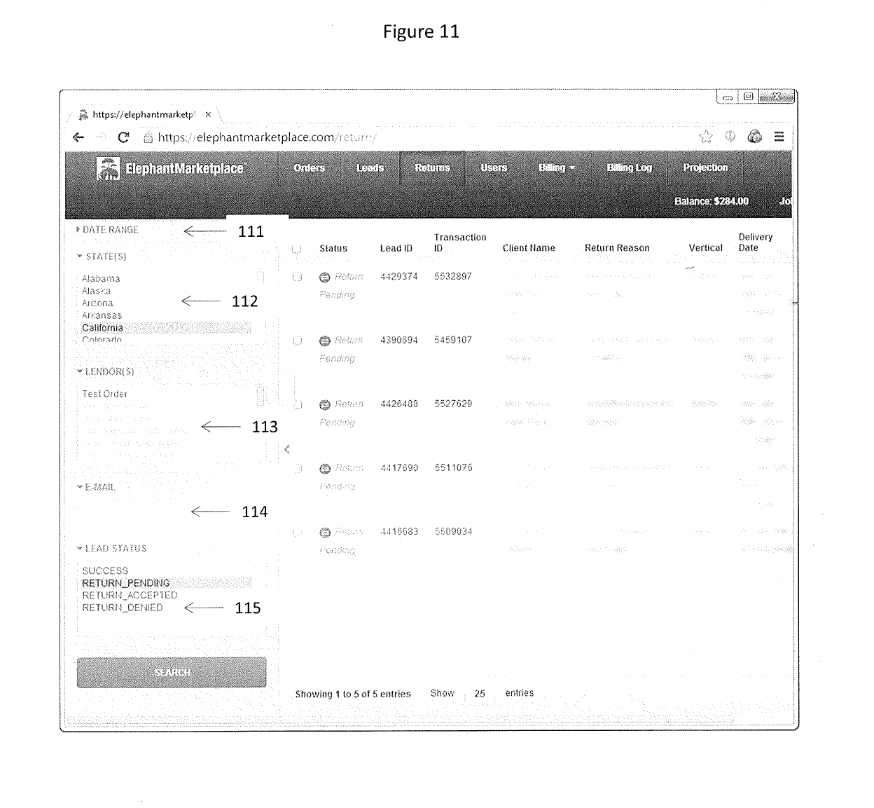

FIG. 10 depicts a graphical user interface used to view detailed lead information when the Lead Details action button is used in FIG. 9. FIG. 11 depicts a graphical user interface used by lead vendors to act on lead return requests. Through the interface, lead vendors can display leads based on filters. Filters vary by lead type. In this implementation, leads can be filtered by return request date 111, state 112, order name 113, buyer email 114, and lead status 115.

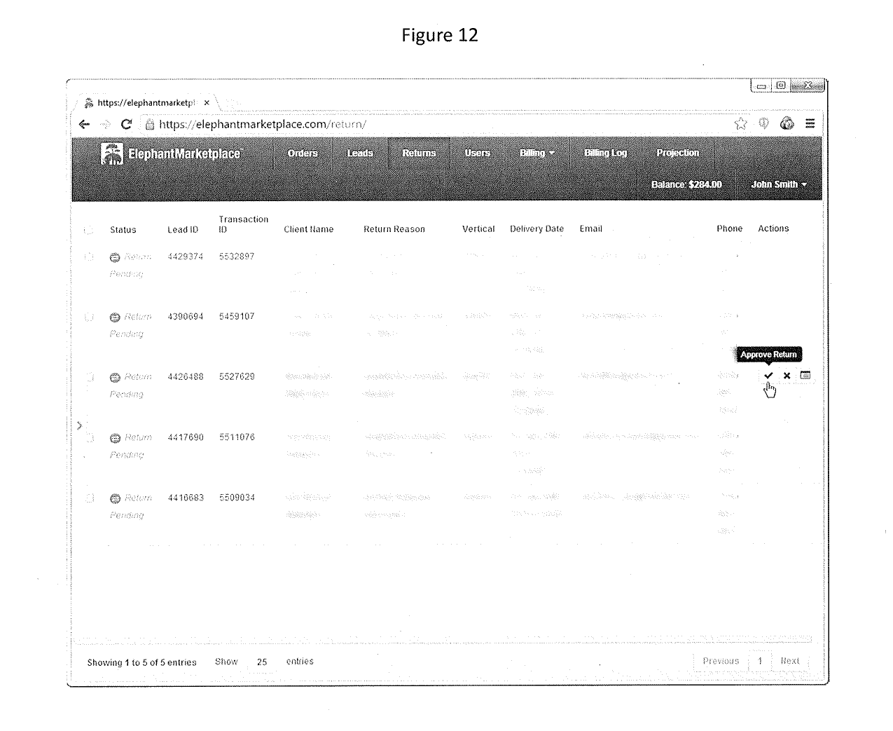

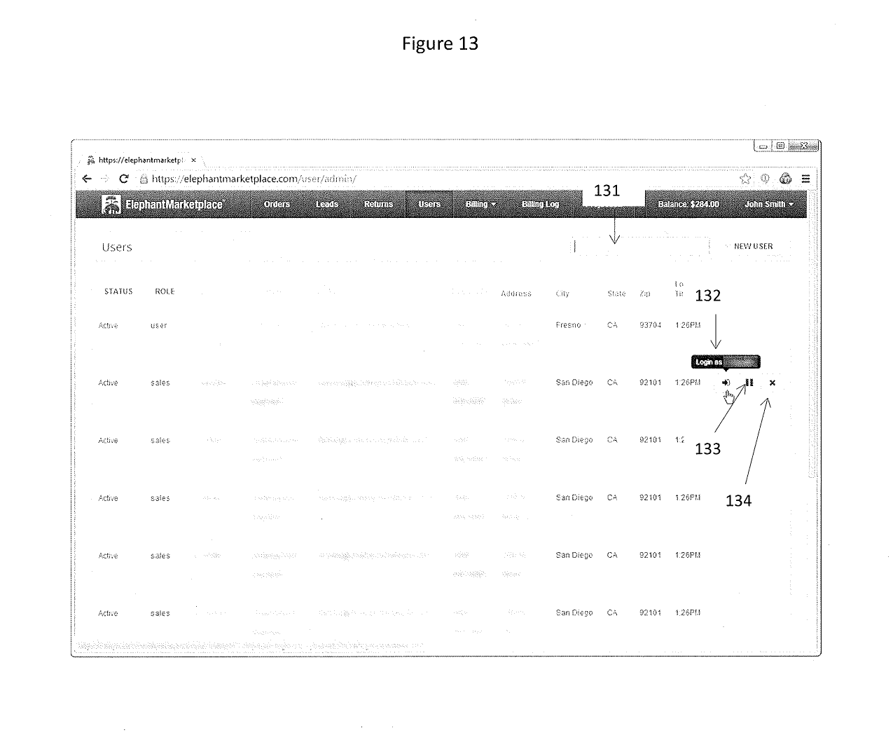

FIG. 12 depicts a graphical user interface from FIG. 11 with the filter menu collapsed. Through this interface, lead vendors can view details about leads as well as approve or deny return requests. FIG. 13 depicts a graphical user interface used lead vendors to manage system users. Through the interface, lead vendors can search for specific users 131, log into the system as a user 132, deactivate a user 133 and delete a user 134.

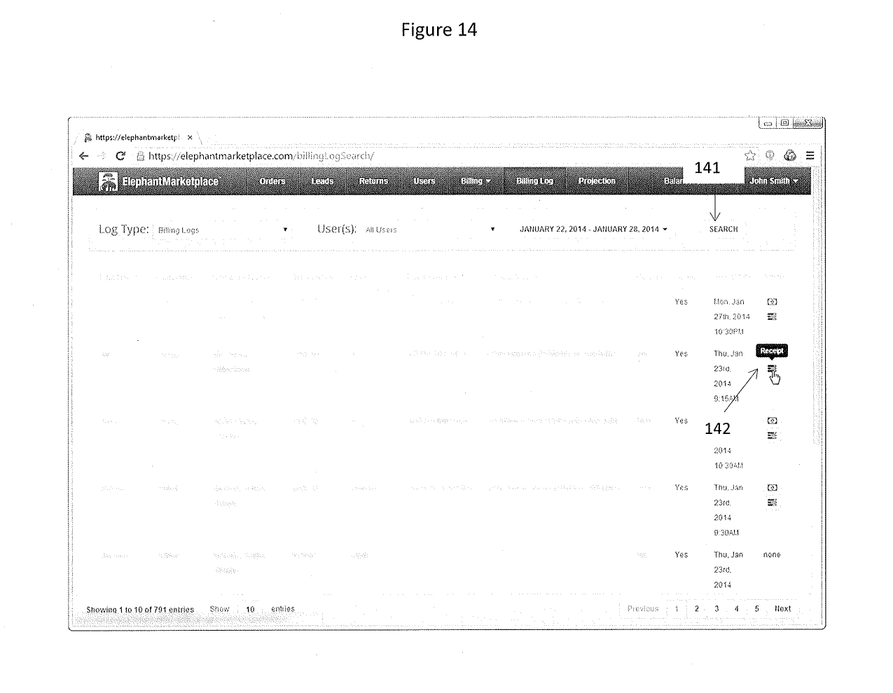

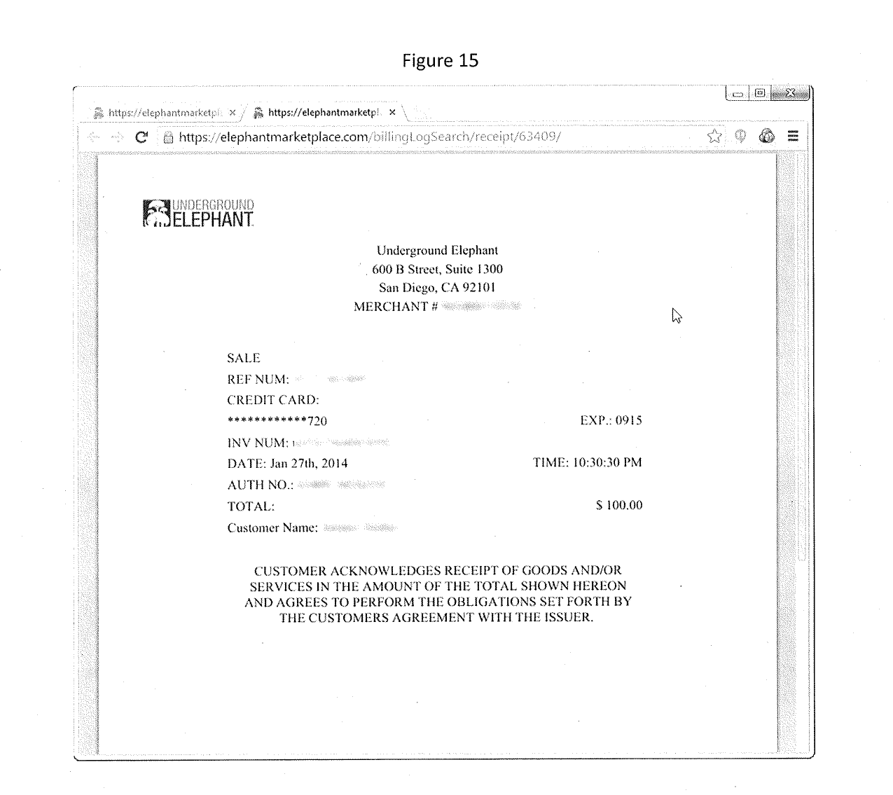

FIG. 14 depicts a graphical user interface used by lead vendors to view and manage billing transactions. Through the interface, lead vendors can locate using filters 141 and view specifics about every billing transaction. Further, receipts 142 may be generated in PDF form. FIG. 15 depicts an example of a receipt created through the interface depicted in FIG. 14.

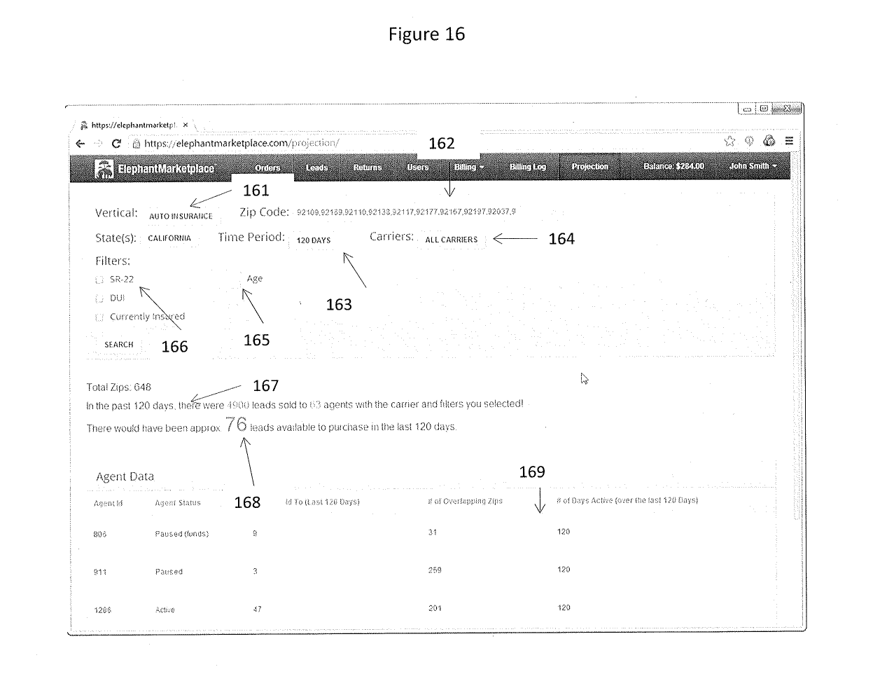

FIG. 16 depicts a graphical user interface used by lead buyers and lead vendors to view leads previously made available for sale through the system. Through the interface, users can input criteria specific to lead types in order to get descriptive statistics about historic lead volume. In this implementation, auto insurance leads 161 can be filtered by geography 162, date generated 163, insurance carrier 164, age 165, and risk factors 166. Descriptive statistics provided cover overall lead volume based on the filters specified 167 as well as how many leads a new agent would have received during the selected period 168. Further, the interface displays orders 169 from other buyers that would have competed for leads with a new buyer.

The system optimizes revenue per lead for the lead vendor by selling to the highest bidding eligible order. Orders that have reached their daily maximum allocation or are inactive are not eligible. If two orders have the same winning bids, the system will distribute available leads in equal portions and in circular order.

Lead vendors can specify rules that automatically remove leads from inventory prior to being sold. Data used by the rules can come from the lead itself as well as data values and quality scores from third-party sources. Common examples of leads that are removed involve those with a consumer name (such as “Mickey Mouse” for example) and duplicates. Lead vendors can specify the maximum number of times that a non-exclusive lead can be sold. Lead vendors can modify leads and add them to available inventory.

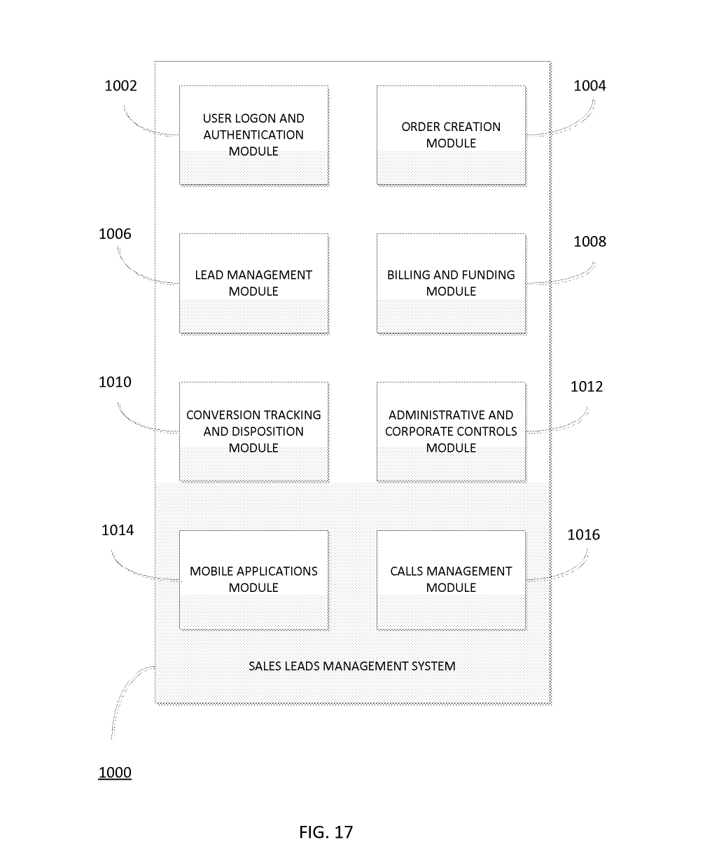

FIG. 17 is a functional block diagram of a system 1000 for creating, managing and fulfilling sales lead orders. The system 1000 includes a user logon and authentication module 1000 that provides a user management tool that supports standard user functions such as login, user registration password and reset. In some implementations, the user logon and authentication module 1000 allows users to be organized in a hierarchy, so that authentication rules can be applied to different groups of users. Every application component, page, and feature can be independently secured. The user logon and authentication module 1000 is an administrative function that lets a system administrator change any user's settings, and login as any user.

The system 1000 system further includes an order creation module 1004 to create and manage lead orders, a lead management module 1006 to manage leads from lead vendors as well as various interactive tools for viewing lead actions, and a billing and funding module 1008 to manage financial transactions occurring on the system 1000. The functionality of each of these integrated modules is discussed in further detail below. The system 1000 further includes a conversion tracking and disposition data module 1010, an administrative and corporate controls module 1012, a mobile applications module 1014, and a calls management module 1016, which are also described in further detail below.

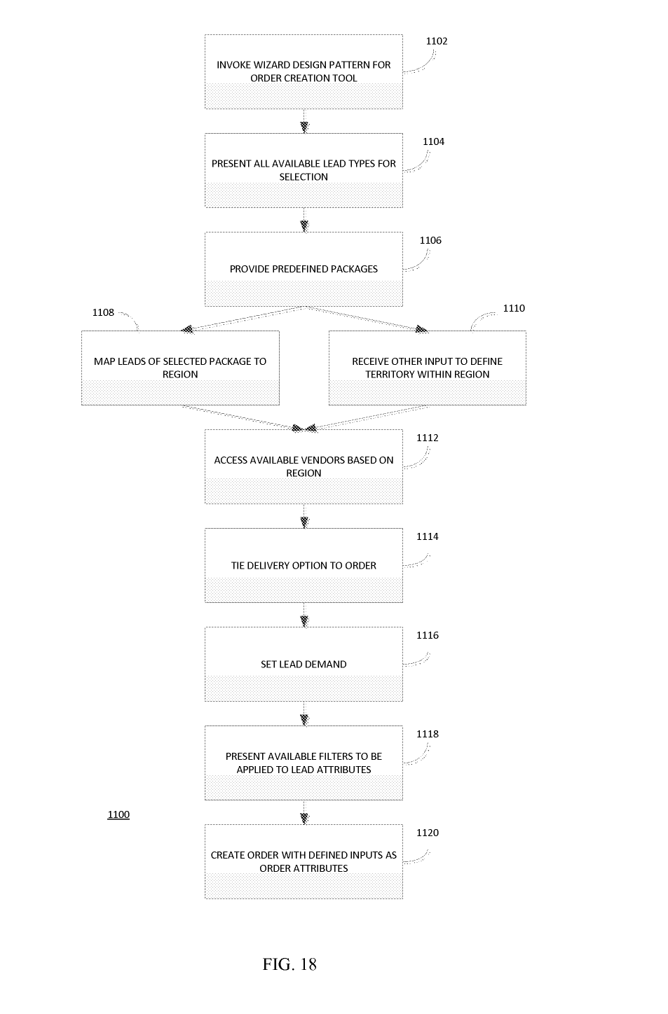

FIG. 18 illustrates a process 1100 executed by the order creation module 1004, in accordance with some implementations. At 1102, a wizard design pattern is invoked by the order creation module 1004, to guide the user through the process 1100 for creating a lead order. At 1104, the order creation module 1004 presents all available lead types for selection 1104. The presentation can be in a graphical user interface or other visual display, such as one or more of the graphical user interfaces described above. At 1106, the order creation module 1004 provides predefined packages of leads for selection. The packages contain presets for all available order options. The selected package is sent to the order creation module 1004, and the associated settings are selected.

At 1108, leads are mapped to a region, or at 1110 other input is received to define a territory within a region. For instance, the wizard displays an easy to use map interface. The interface takes a zip code and radius as input. The map displays the area selected, with the defined radius highlighted. The actual postal codes are displayed, and the system can select/deselect particular postal codes. Alternatively, or in addition, the map is also designed to take other types of input. e.g., a state/province can be passed as input to have that area highlighted and selected (on the backend, all zip codes in the province will be accessed). The system can also use defined “territories,” or groups of postal codes.

At 1112, available vendors are accessed based on the region. The order creation module 1004 takes a geographical area as a set of postal codes as input, and hooks into available vendors. This data is presented as a list of vendors, along with volume projections in the given area. A vendor is selected as input. At 1114, delivery options are associated with an order. The system 1000 is integrated with several delivery methods (e.g., email, CRM post, etc.). The order creation module 1004 allows one or all options to be tied to the order. There is also an option to be notified via SMS when a new lead is received by the system 1000. At 1116, lead demand can be established. The order creation module 1004 takes daily, weekly, and monthly values as input in order to set the lead demand of the order (caps), and can also take a dayparting schedule as an input, so that leads are only delivered during a given time frame (time of day and/or day of week).

At 1118, available filters to be applied to lead attributes are presented. The order creation module 1004 presents available filters to be applied to lead attributes, and takes filter sets and values as input, and assigns them to the order. Finally, at 1120, the order creation module 1004 creates the order with all of the defined inputs as order attributes. The system 1000 displays all orders on the order screen, where they can be activated, paused, and edited. An “edit order” function uses a similar feature as for order creation, but edits an existing order rather than creating a new one. When an order is paused, the system 1000 can take a reactivation date as input, and the order will automatically be activated on that date.

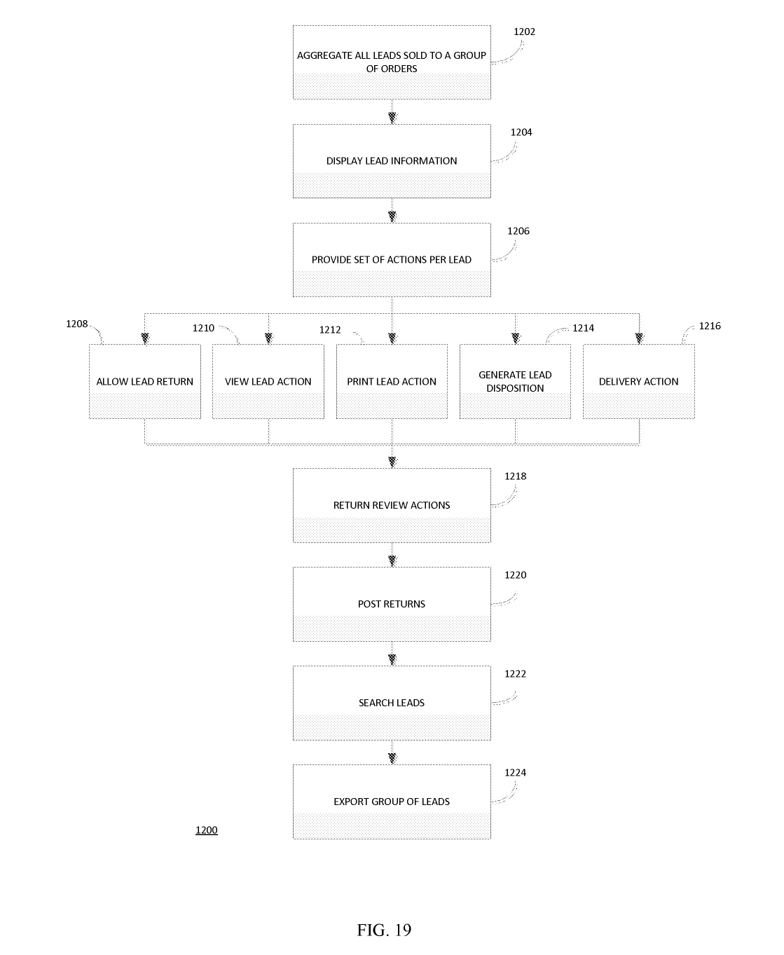

FIG. 19 illustrates a process 1200 executed by the lead management module 1006, in accordance with some implementations. At 1202, the lead management module 1006 aggregates all leads sold to a group of orders. These orders might be associated with a user, or a group of users. At 1204, the lead management module 1006 displays lead information, such as PII, lead status, and the associated order, user, and/or group.

At 1206, a set of actions for every lead is provided by the lead management module 1006. These actions can be displayed in a drop down menu, or as a set of graphical control buttons, etc. The actions include, without limitation, an ability to have a lead returned, at 1208. This action sends the lead to the lead's vendor along with a return reason that is selected from a group of predefined reasons. The lead status is also changed. Another action, at 1210, is a “view lead” action, in which all lead details are displayed and made viewable to a user. At 1212, lead details can be printed, based on the user interface of the lead management module 1006. At 1214, another action of the lead management module 1006 is a “disposition” action, where the lead management module 1006 can take a new status as input: contacted, returned, closed, left voicemail, etc. At 1216, a delivery action allows a lead to be redelivered to the order-defined delivery channels, as described above.

At 1218, the lead management module 1006 provides return review actions to lead vendors, who can view, approve, or deny lead return requests. Vendors deny returns by selecting a deny reason from a list of predefined reasons provided by the system 1000. The lead management module 1006 also provides an API for return reviews to be posted programmatically, at 1220. The lead, review status, and deny reasons can all be posted and updated in the system 1000. At 1222, the lead management module 1006 provides a search function which can show a subset of leads based on a search input, whereby any attribute of the lead can be searched. Finally, at 1224, the lead management module 1006 provides an export function that allows a group of leads to be exported from the system 1000 to any third party computing platform.

The billing and funding module 1008 provides an interface to enter credit card or other financial transaction tool information. Multiple account numbers can be added and managed. The account information is passed to an offline merchant account, and a corresponding identifier is stored in the system 1000, such that no account information is stored on the system 1000 server(s). The billing and funding module 1008 can be used to add funds from any available account. The billing and funding module 1008 provides an optional continuous billing component, which automatically withdraws funds from a selected account when a balance for the associated customer is below a target or predetermined threshold. The billing and funding module 1008 also provides a log of all transactions, and provides various options to view and print reports.

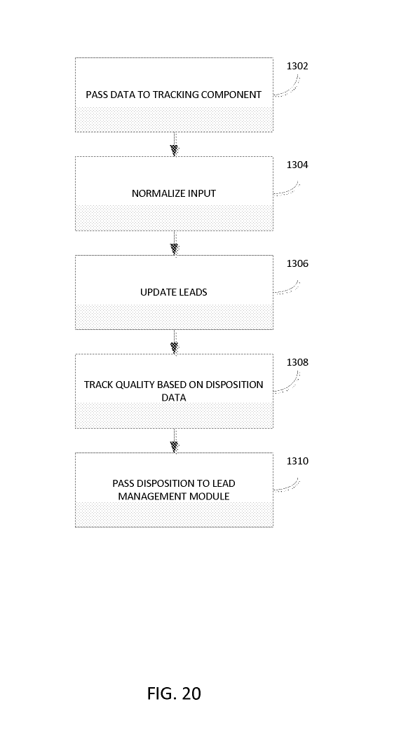

FIG. 20 illustrates a process 1300 executed by the conversion tracking and disposition data module 1010, in accordance with some implementations. At 1302, data is passed to the conversion tracking and disposition data module 1010 via an API or by user input. At 1304, the input is normalized and matched with lead data. At 1306, matched leads are updated with information in the input data. At 1308, the conversion tracking and disposition data module 1010 tracks quality of the leads by source, agent, and other metrics, based on disposition data for each lead. The conversion tracking and disposition data module 1010 tracks the disposition of each lead through the process, and generates the disposition data. At 1310, the conversion tracking and disposition data module 1010 passes the disposition data and quality data to the lead management module 1006. This data can also be used by the system 1000 for reports and vendor rankings

The administrative and corporate controls module 1012 provides platform-wide reports on lead volume and/or quality, user interaction, etc. The system 1000 employs the administrative and corporate controls module 1012 as a way to view user information, and to allow login as any user. The administrative and corporate controls module 1012 further provides a dashboard or other user interface, to change user settings and turn user access on or off.

The mobile applications module 1014 provides access to the system 1000 by any of a number of mobile applications that are available for any mobile operating system. In preferred implementations, the mobile applications are implemented as web-based functionality. Preferably, each application can send the user “push” notification, such as native notifications that occur outside of the application. Such notifications can alert a user, using the application on an associated mobile device, when a new lead arrives to the system 1000. The mobile application can then automatically call an incoming lead, and connect the user with the lead. The mobile application can also utilize location services of the mobile device to match leads to a dynamic location of the user. The functions and activities conducted with the mobile application are tracked, processed and at least partially stored by the system 1000.

The calls management module 1014 provides an online and integrated platform to buy and sell live calls. The calls management module 1014 includes an interface to receive a destination phone or pool of phone numbers to which live calls can be transferred. The calls management module 1014 further include a management interface that provides a way for calls to be turned on/off, and also set on a schedule. A map interface can be included to graphically specify an area from which to receive calls. The calls management module 1014 also handles leads, so that call-verified leads can flow through the system 1000.

The calls management module 1014 includes a calls API to allow a call publisher to offer a live (i.e. real-time) transfer. If there is a matching order, the calls management module 1014 will respond to the publisher with a bid price and destination phone number. The publisher then transfers the call, while also posting the lead data to the calls API. Accordingly, the call can be sold as a transfer, and/or the lead is sold as a call-verified lead.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT), a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying FIG.s and/or described herein do not necessarily require the particular order shown, or sequential order, to achieve desirable results. Other implementations may be within the scope of the following claims.

What is claimed is:

1. A method comprising:
creating, by at least one data processor, a new order for sales leads, the creating being based on one or more predefined properties of the sales leads specified by a user, the new order specifying a number of the sales leads to be transmitted electronically to a customer;
generating, by at least one data processor, one or more profile elements for the number of the sales leads, the one or more profile elements defining a plurality of segments of the number of the sales leads;
calculating, by at least one data processor, a pricing structure for the number of the sales leads based on the one or more profile elements;
providing, by at least one data processor, the new order and the pricing structure to the customer electronically via a communications network; and
receiving, by at least one data processor via the communications network, a selection by the customer of one or more of the plurality of segments of the number of sales leads, the selection further defining a price for the selection based on the pricing structure.

2. The method in accordance with claim 1, further comprising tracking, by at least one data processor, a conversion into a buyer for each sales lead in the selection.

3. The method in accordance with claim 2, further comprising calculating, by at least one date processor, a conversion rate for the selection based on the conversion for each sales lead in the selection.

4. The method in accordance with claim 1, further comprising defining, by at least one data processor, a set of key performance indicators for the selection of the one or more of the plurality of segments of the number of sales leads.

5. The method in accordance with claim 4, further comprising comparing, by at least one data processor, a performance of at least one the one or more of the plurality of segments of the number of sales leads with the set of key performance indicators to generate a performance score.

6. The method in accordance with claim 1, wherein the one or more predefined properties includes a geographic region of a location of the sales leads.

7. The method in accordance with claim 1, wherein the one or more profile elements includes a demographic profile for at least one of the plurality of segments of the number of the sales leads.

8. A non-transitory computer program product storing instructions that, when executed by at least one programmable processor, cause the at least one programmable processor to perform operations comprising:
creating a new order for sales leads, the creating being based on one or more predefined properties of the sales leads specified by a user, the new order specifying a number of the sales leads to be transmitted electronically to a customer;
generating one or more profile elements for the number of the sales leads, the one or more profile elements defining a plurality of segments of the number of the sales leads;
calculating a pricing structure for the number of the sales leads based on the one or more profile elements;
providing the new order and the pricing structure to the customer; and
receiving a selection by the customer of one or more of the plurality of segments of the number of sales leads, the selection further defining a price for the selection based on the pricing structure.

9. The computer program product in accordance with claim 8, wherein the operations further comprise tracking a conversion into a buyer for each sales lead in the selection.

10. The computer program product in accordance with claim 9, wherein the operations further comprise calculating a conversion rate for the selection based on the conversion for each sales lead in the selection.

11. The computer program product in accordance with claim 8, wherein the operations further comprise defining a set of key performance indicators for the selection of the one or more of the plurality of segments of the number of sales leads.

12. The computer program product in accordance with claim 11, wherein the operations further comprise comparing a performance of at least one the one or more of the plurality of segments of the number of sales leads with the set of key performance indicators to generate a performance score.

13. The computer program product in accordance with claim 8, wherein the one or more predefined properties includes a geographic region of a location of the sales leads.

14. The computer program product in accordance with claim 1, wherein the one or more profile elements includes a demographic profile for at least one of the plurality of segments of the number of the sales leads.

15. A system comprising:
at least one programmable processor; and
a machine-readable medium storing instructions that, when executed by the at least one processor, cause the at least one programmable processor to perform operations comprising:
create a new order for sales leads, the creating being based on one or more predefined properties of the sales leads specified by a user, the new order specifying a number of the sales leads to be transmitted electronically to a customer;
generate one or more profile elements for the number of the sales leads, the one or more profile elements defining a plurality of segments of the number of the sales leads;
calculate a pricing structure for the number of the sales leads based on the one or more profile elements;
provide the new order and the pricing structure to the customer; and
receive a selection by the customer of one or more of the plurality of segments of the number of sales leads, the selection further defining a price for the selection based on the pricing structure.

16. The method in accordance with claim 15, further comprising tracking, by at least one data processor, a conversion into a buyer for each sales lead in the selection.

17. The method in accordance with claim 16, further comprising calculating, by at least one date processor, a conversion rate for the selection based on the conversion for each sales lead in the selection.

18. The method in accordance with claim 15, further comprising defining, by at least one data processor, a set of key performance indicators for the selection of the one or more of the plurality of segments of the number of sales leads.

19. The method in accordance with claim 18, further comprising comparing, by at least one data processor, a performance of at least one the one or more of the plurality of segments of the number of sales leads with the set of key performance indicators to generate a performance score.

20. The method in accordance with claim 15, wherein the one or more predefined properties includes a geographic region of a location of the sales leads.

21. The method in accordance with claim 15, wherein the one or more profile elements includes a demographic profile for at least one of the plurality of segments of the number of the sales leads.
